(19) United States
(12) Patent Application Publication
(10) Pub. No.: US 2026/0113614 A1
(43) Pub. Date: Apr. 23, 2026

(54) FLIGHTPATH SERVER IN CORE NETWORK

(71) Applicant: QUALCOMM Incorporated, San Diego, CA (US)

(72) Inventors: Chiranjib SAHA, Lakeside, CA (US); Sunghoon KIM, San Diego, CA (US); Umesh PHUYAL, San Diego, CA (US); Stefano FACCIN, San Ysidro, CA (US); Le LIU, San Jose, CA (US); Alberto RICO ALVARINO, San Diego, CA (US); Haris ZISIMOPOULOS, London (GB)

(21) Appl. No.: 19/111,444

(22) PCT Filed: Oct. 9, 2023
(86) PCT No.: PCT/US2023/034757

§ 371 Date: Mar. 13, 2025

(30) Foreign Application Priority Data
Nov. 9, 2022 (GR) 20220100920

(51) Int. Cl. H04W 8/02

(52) U.S. Cl. CPC H04W 8/02

(57) ABSTRACT

An apparatus may be a first network entity configured to receive, from a second network entity or a first wireless device, first information regarding a flightpath of at least one wireless device, receive, from the second network entity or the first wireless device, an indication to store second information regarding the flightpath of the at least one wireless device based on the first information, and transmit, to a third network entity based on the second information, third information regarding the flightpath of the at least one wireless device. An apparatus may be a second network entity configured to receive, from a first wireless device, first information regarding a flightpath of at least one wireless device and transmit, to a first network entity, an indication to store second information regarding the flightpath of the at least one wireless device.

### CROSS-REFERENCE TO RELATED APPLICATION

This application claims the benefit of Greece Patent Application Serial No. 20220100920, entitled “FLIGHTPATH SERVER IN CORE NETWORK” and filed on Nov. 9, 2022, which is expressly incorporated by reference herein in its entirety.

### TECHNICAL FIELD

The present disclosure relates generally to communication systems, and more particularly, to communication and control systems related to unmanned aerial vehicles (UAVs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network entity configured to receive, from a second network entity or a first wireless device, first information regarding a flightpath of at least one wireless device. The apparatus may further be configured to receive, from the second network entity or the first wireless device, an indication to store second information regarding the flightpath of the at least one wireless device based on the first information. The apparatus may also be configured to transmit, to a third network entity based on the second information, third information regarding the flightpath of the at least one wireless device.

In an aspect of the disclosure, a method, a computer-readable medium, and an apparatus are provided. The apparatus may be a second network entity configured to receive, from a first wireless device, first information regarding a flightpath of at least one wireless device. The apparatus may further be configured to transmit, to a first network entity, an indication to store second information regarding the flightpath of the at least one wireless device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a call flow diagram illustrating a FP information storage and FP information authorization and/or FP information verification function in an environment in accordance with some aspects of the disclosure.

FIG. 6 is a call flow diagram illustrating a FP information storage and retrieval function of FP information authorization and/or FP information verification function in an environment in accordance with some aspects of the disclosure.

FIG. 7 is a call flow diagram illustrating a FP information storage and retrieval function of FP information authorization and/or FP information verification function in an environment in accordance with some aspects of the disclosure.

FIG. 8 illustrates components of a system including a UAS-NF implementing FP server interacting with an external server, USS, and core network associated with a NG-RAN and at least one UE/UAV in accordance with some aspects of the disclosure.

FIG. 9 is a flowchart of a method of wireless communication.

FIG. 10 is a flowchart of a method of wireless communication.

The means may be the FP server component of the network entity 1460 configured to perform the functions described in relation to FIGS. 9-11 and recited by the means.

FIG. 11A is a flowchart of a method of wireless communication.

FIG. 11B is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for a network entity.

FIG. 15 is a diagram illustrating an example of a hardware implementation for a network entity.

### DETAILED DESCRIPTION

In some aspects of wireless communication, a wireless device such as a user equipment (UE) or a UAV may report flightpath (FP) information to a RAN and an access and mobility management function (AMF) of a core network. The radio access network (RAN) and/or AMF may not store FP information for later use and may subsequently request FP information from the UE or UAV, e.g., via the air interface and/or radio resource control (RRC) signaling. Accordingly, the FP information may be unavailable or if a context for the UE or the UAV is lost at a RAN node or the AMF, e.g., if the UE or the UAV is in an RRC IDLE mode or is handed over to be served by another cell. The FP information, in some aspects, may also be provided to an external server, e.g., a UAV administration server (UAS) service supplier (USS) or an unmanned aircraft system traffic management (UTM) server, used to coordinate among UAVs associated with different networks (e.g., RANs). In some aspects, the USS or UTM server may be a country-specific service supplier or server, e.g., associated with a civil aviation authority. A FP server, in some aspects, may be provided in a core network to store FP information received from one or more of the UE, UAV, USS, UTM, or other source and provide FP information management in the core network.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

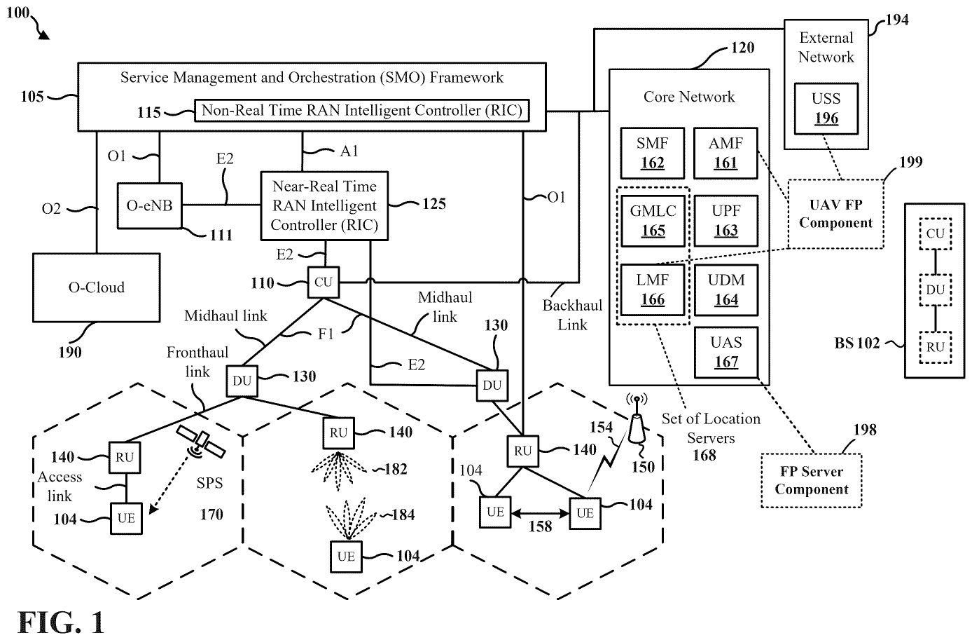

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, a UAS 167, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

In some aspects, the core network components may interact with components of an external network 194. The external network may include a USS 196 or a UTM server (not shown). The external network 194 may be associated with management functions of UAVs associated with the core network 120.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the core network 120 may be configured with a UAS 167 including a FP server component 198 that may be configured to receive, from a second network entity or a first wireless device, first information regarding a flightpath of at least one wireless device. The FP server component 198 may further be configured to receive, from the second network entity or the first wireless device, an indication to store second information regarding the flightpath of the at least one wireless device based on the first information. The FP server component 198 may also be configured to transmit, to a third network entity based on the second information, third information regarding the flightpath of the at least one wireless device. In certain aspects, the core network 120 may further be configured with an AMF 161 and/or LMF 166 that may include a UAV FP component 199 that may be configured to receive, from a first wireless device, first information regarding a flightpath of at least one wireless device. The UAV FP component 199 may further be configured to transmit, to a first network entity, an indication to store second information regarding the flightpath of the at least one wireless device. Although the following description may be focused on 5G NR, the concepts described herein may be applicable to other similar areas, such as LTE, LTE-A, CDMA, GSM, and other wireless technologies.

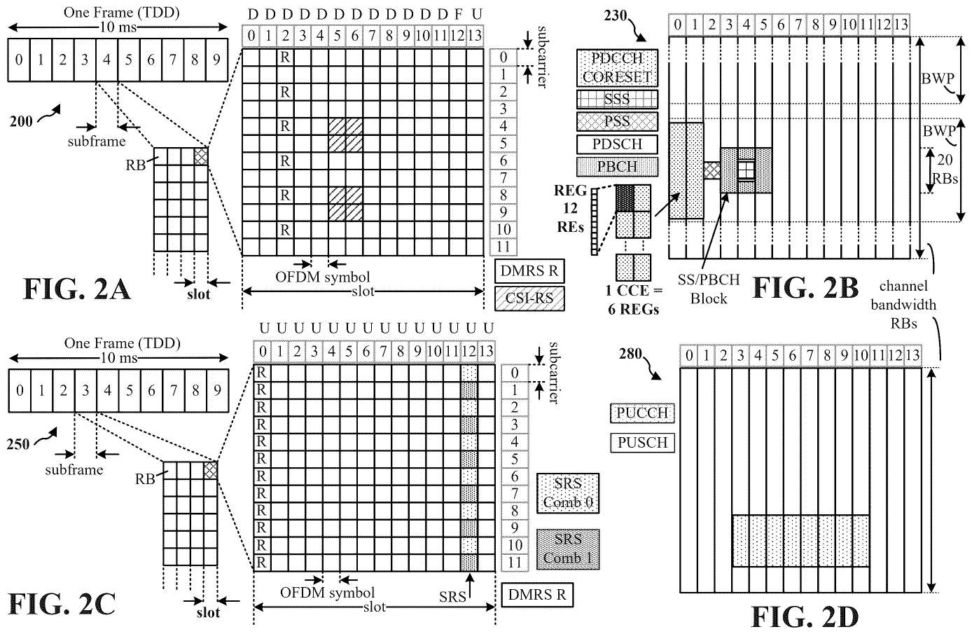

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

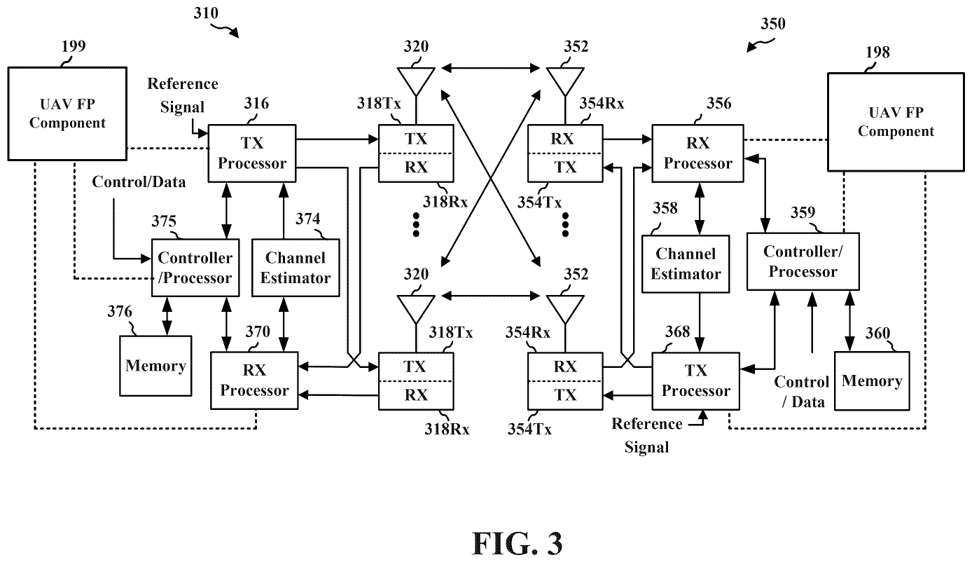

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the FP server component 198 of FIG. 1.

At least one of the TX processor 316, the RX processor 370, and the controller/processor 375 may be configured to perform aspects in connection with the UAV FP component 199 of FIG. 1.

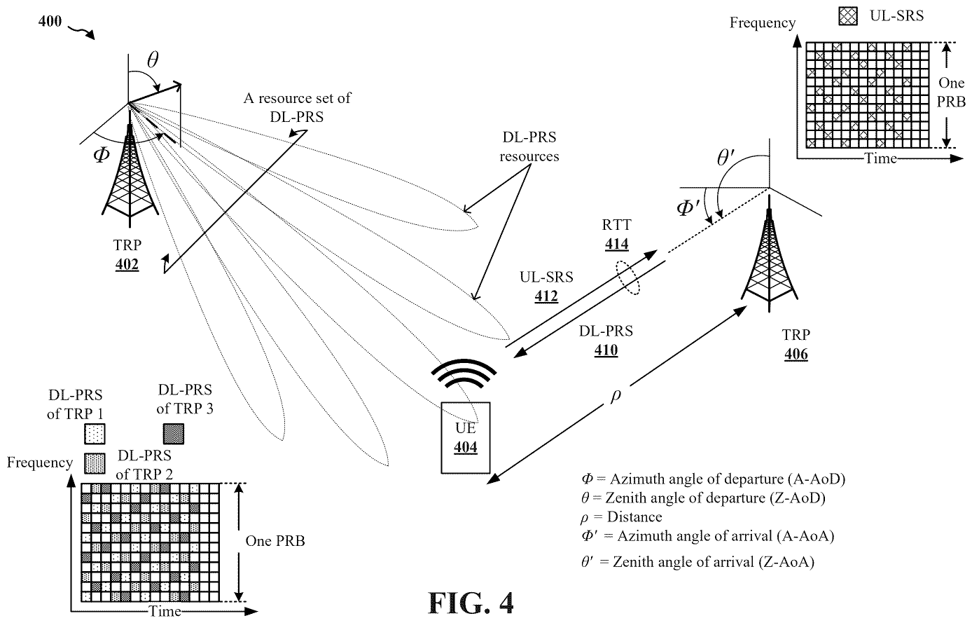

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402,406 measure the UL-RTOA (and UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In some aspects of wireless communication, a wireless device such as a UE or a UAV may report FP information to a RAN and an AMF (e.g., AMF 161 of FIG. 1) of a core network. The RAN and/or AMF may not store FP information for later use and may subsequently request FP information from the UE or UAV, e.g., via the air interface and/or RRC signaling. Accordingly, the FP information may be unavailable or if a context for the UE or the UAV is lost at a RAN node or the AMF, e.g., if the UE or the UAV is in an RRC IDLE mode or is handed over to be served by another cell. The FP information, in some aspects, may also be provided to an external server, e.g., a USS or UTM server, used to coordinate among UAVs associated with different networks (e.g., RANs). In some aspects, the USS or UTM server may be a country-specific service supplier or server, e.g., associated with a civil aviation authority.

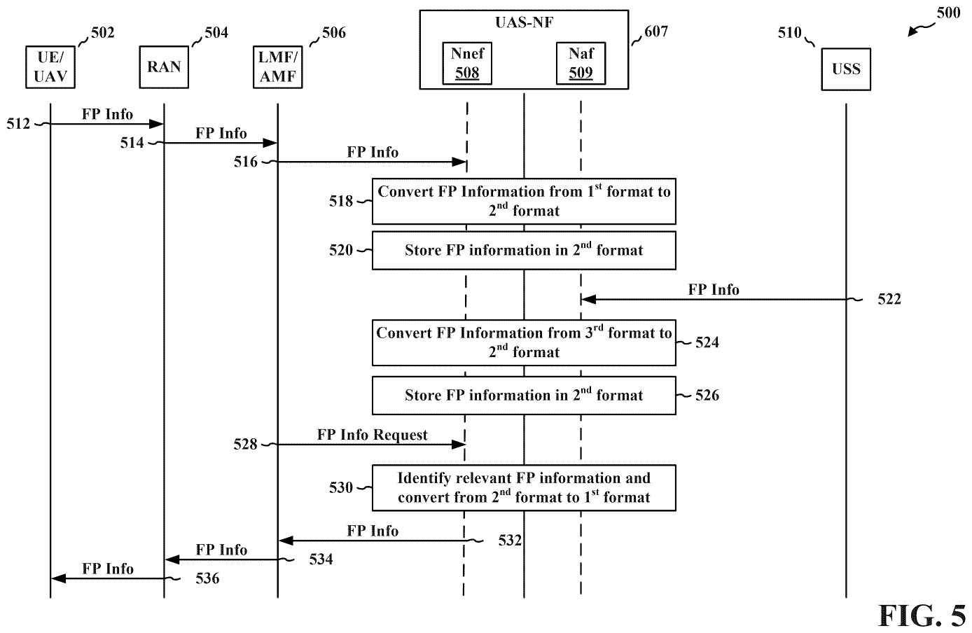

In some aspects, a UAS network function (UAS-NF) may be provided within a core network to provide services for UAVs and/or UEs associated with the core network. The UAS-NF may be associated with a core network and may be supported by a network exposure function (NEF) and/or a service capability exposure function (SCEF) of the core network. In some aspects, the UAS-NF may use NEF and/or SCEF exposure services for UAV authentication and/or authorization, for UAV flight authorization, for UAV-UAV controller (UAV-UAVC) pairing authorization, related re-authentication and/or re-authorization or revocation. The UAS-NF, in some aspects, may use the NEF and/or SCEF for location reporting, presence monitoring, obtaining list of aerial UEs in a geographic area and control of QoS and/or traffic filtering for command and control (C2) communication. The UAS-NF may coordinate, in some aspects, with the USS to assist civilian aviation authority (CAA) level UAV ID assignment. FIGS. 5-7 illustrate different functions that may be provided and/or implemented by FP server implemented in a UAS-NF.

FIG. 5 is a call flow diagram 500 illustrating a FP information storage and FP information authorization and/or FP information verification function in an environment in accordance with some aspects of the disclosure. A UE/UAV 502, in some aspects, may transmit FP information 512 to an associated RAN 504 (e.g., a NG-RAN). The UE/UAV 502, in some aspects, may be a UE, a UAV, a drone, or other component of the RAN 504. The FP information 512 provided, in some aspects, by the UE/UAV 502 may indicate and/or identify a sequence of waypoints. The waypoints, in some aspects, may be locations associated with a planned flightpath. The sequence of waypoints, in some aspects, may be represented in one or more geographic area descriptions (GADs). In some aspects, the waypoints may be indicated, e.g., for a universal mobile telecommunication system (UMTS), via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. The sequence of waypoints, in some aspects, may be associated with a set of timestamps (e.g., a sequence of timestamps corresponding to the sequence of waypoints). The set of timestamps, in some aspects, may include one or more of absolute timestamps (e.g., timestamps expressed in relation to a global or shared reference frame) or a relative time (e.g., a timestamp expressed in relation to a local time kept at the UE/UAV 502 or in relation to a beginning or ending waypoint of a FP). The FP information 512 may also include at least one ID of the UE/UAV 502. The at least one ID, in some aspects, may be one of a general public subscription identifier (GPSI) or a subscription permanent identifier (SUPI). The FP information 512, in some aspects, may be provided in a first format associated with the UE/UAV 502 or the RAN 504.

The RAN 504, in some aspects, may then provide the FP information 514 (e.g., the FP information 512 provided by the UE/UAV 502) to a core network (CN) 506 (e.g., an AMF). The CN 506 may transmit FP information 516 to UAS-NF 507 via Nnef 508 (e.g., an interface provided by the UAS-NF or a FP server implemented within the UAS-NF). The FP information 516, in some aspects, may include an indication to store second information regarding the flightpath of the UE/UAV 502. The UAS-NF 507 (or the FP server implemented by the UAS-NF 507) may, if the first format is not the same as a format used by the UAS-NF 507, convert at 518 the FP information 516 received in the first format into a second format used to store at 520 FP information in the UAS-NF (or FP server). In some aspects, the UAS-NF 507 may not convert the FP information 516 if the first format is the same as the second format used to store FP information at the UAS-NF. Alternatively, or additionally, the UAS-NF 507 may not convert the FP information 516 from the first format to the second format and, in some aspects, may store the FP information 516 in the first format along with an indication that the FP information is stored in the first format.

The UAS-NF 507 may, in some aspects, convert at 522 the FP information stored at 520 from the second format (or another format in which the FP information is stored) into a third format. The conversion at 522, in some aspects, may be triggered by an event associated with an authentication or verification operation. For example, an authorization and/or verification operation may be performed upon receiving FP information from a UE and/or UAV (e.g., UE/UAV 502). The FP information converted at 522 may be provided, via an interface such as Naf 509, as FP information 524 to a USS 510 as part of an authorization and/or verification operation (e.g., via a function call such as “Naf_FlightPathInfoVerify”). Based on the FP information 524, the USS may process at 526 the FP information 524. The processing at 526 may include, in some aspects, checking the FP information 524 against FP information associated with one or more UEs/UAVs or locations (e.g., including the UE/UAV 502 and other related UEs or UAVs associated with a particular location or area) stored at the USS 510 to verify and/or authorize the FP indicated in the FP information 524. In some aspects, the processing at 526 may include associating the FP information 524 (e.g., including one of a GPSI or SUPI) with an identifier assigned by the USS or a related CAA-assigned ID.

Based on processing at 526 the FP information 524, the USS may transmit FP information 528. The FP information 528, in some aspects, may include FP information in the third format. In some aspects, the FP information 528 may include verification information indicating whether the FP information 524 is consistent with FP information regarding the FP of the UE/UAV 502 stored at the USS 510. The FP information 528, in some aspects, may include authorization information.

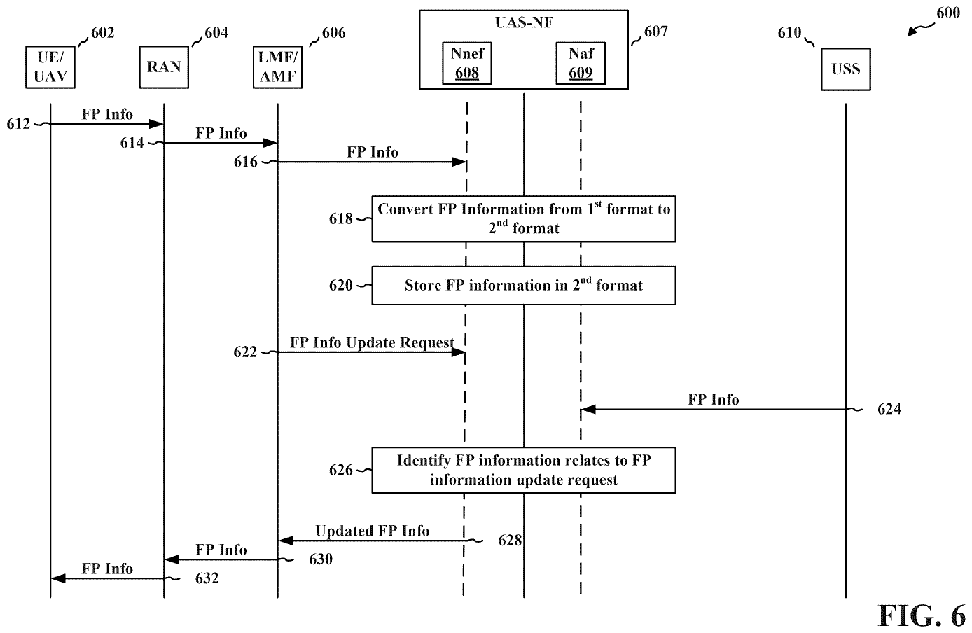

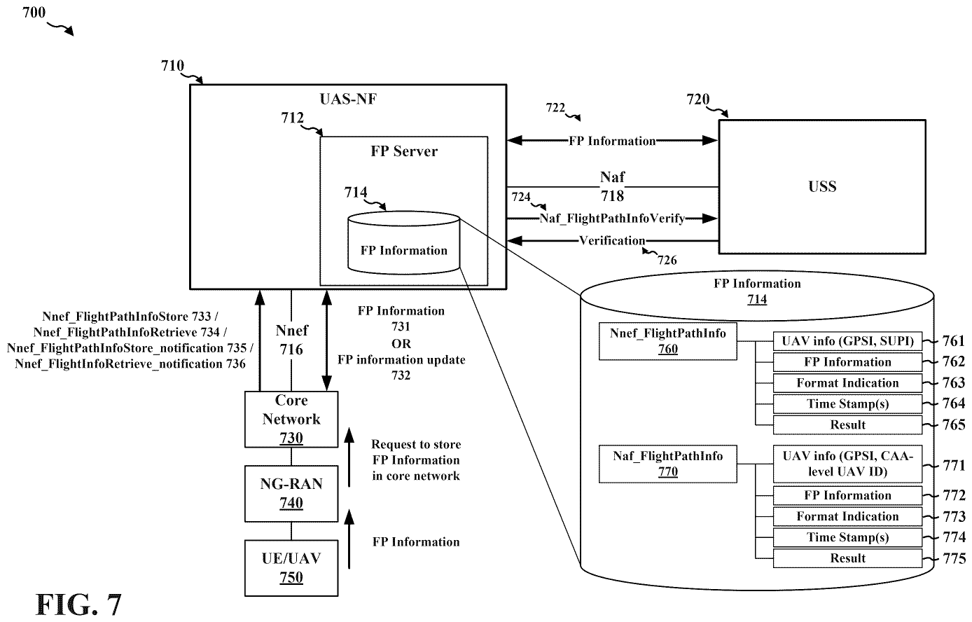

In some aspects, the UAS-NF 507 may process at 530 the FP information 528 to determine whether information included in FP information 528 should be reported, or communicated, to the CN 506 (e.g., an AMF or LMF of the CN 506) and ultimately to the UE/UAV 502 or other UEs or UAVs associated with the CN 506. The determination may be based on additional communication (e.g., requests for stored or updated FP information) from the CN 506, e.g., as described below in relation to FIGS. 6 and 7. The UAS-NF 507 may transmit, and CN 506 may receive FP information 532. The CN 506 may transmit FP information 534 to RAN 504 for the RAN 504 to transmit to UE/UAV 502 as FP information 536. In some aspects, the RAN 504 may alternatively, or additionally, transmit FP information based on one or more of FP information 528, 532, or 534 to one or more other UEs or UAVs associated with the CN 506 or the RAN 504.

FIG. 6 is a call flow diagram 600 illustrating a FP information storage and retrieval function of FP information authorization and/or FP information verification function in an environment in accordance with some aspects of the disclosure. A UE/UAV 602, in some aspects, may transmit FP information 612 to an associated RAN 604 (e.g., a NG-RAN). The UE/UAV 602, in some aspects, may be a UE, a UAV, a drone, or other component of the RAN 604. The FP information 612 provided, in some aspects, by the UE/UAV 602 may indicate and/or identify a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. The sequence of waypoints, in some aspects, may be associated with a set of timestamps (e.g., a sequence of timestamps corresponding to the sequence of waypoints). The set of timestamps, in some aspects, may include one or more of absolute timestamps (e.g., timestamps expressed in relation to a global or shared reference frame) or a relative time (e.g., a timestamp expressed in relation to a local time kept at the UE/UAV 602 or in relation to a beginning or ending waypoint of a FP). The FP information 612 may also include at least one ID of the UE/UAV 602. The at least one ID, in some aspects, may be one of a GPSI or a SUPI. The FP information 612, in some aspects, may be provided in a first format associated with the UE/UAV 602 or the RAN 604.

The RAN 604, in some aspects, may then provide the FP information 614 (e.g., the FP information 612 provided by the UE/UAV 602) to a core network (CN) 606 (e.g., an AMF). The CN 606 may transmit FP information 616 to UAS-NF 607 via Nnef 608 (e.g., an interface provided by the UAS-NF or a FP server implemented within the UAS-NF). The FP information 616, in some aspects, may include an indication (e.g., a function call such as “Nnef_FlightInfoStore”) to store second information regarding the flightpath of the UE/UAV 602. The UAS-NF 607 (or the FP server implemented by the UAS-NF 607) may, if the first format is not the same as a format used by the UAS-NF 607, convert at 618 the FP information 616 received in the first format into a second format used to store at 620 FP information in the UAS-NF (or FP server). In some aspects, the UAS-NF 607 may not convert the FP information 616 if the first format is the same as the second format used to store FP information at the UAS-NF. Alternatively, or additionally, the UAS-NF 607 may not convert the FP information 616 from the first format to the second format and, in some aspects, may store the FP information 616 in the first format along with an indication that the FP information is stored in the first format.

In some aspects, the UAS-NF 607 may additionally receive FP information 622 from a USS 610 (or some other external server) via Naf 609. The FP information 622 may indicate FP information associated with one or more UEs or UAVs, e.g., including UE/UAV 602 or other UEs or UAVs associated with the UAS-NF 607 or the CN 606. The FP information, in some aspects, may be transmitted in a third format that is the same as, or different from, the first and second formats. The FP information 622, in some aspects, may be associated with authorization or verification operations performed by the USS 610 and/or the UAS-NF 607. In some aspects, the FP information 622 may include FP information for UEs and/or UAVs not associated with the CN 606 or the RAN 604 but operating in a same location or area as one or more UEs or UAVs associated with the CN 606 or the RAN 604.

The UAS-NF 607 may, in some aspects, convert at 624 the FP information 622 received from the USS 610 into the second format and may store at 626 the FP information 622. As for the FP information 616, in some aspects, the FP information 622 may be stored in the third format in which it was received with an indication of the format for conversion at a later time. The CN 606 may transmit, and the UAS-NF 607 may receive, a request 628 for FP information stored by the UAS-NF 607 (e.g., via a function call such as “Nnef_FlightInfoRetrieve” for current FP information) relating to a particular UE or UAV or a set of UEs and/or UAVs (e.g., one or more UEs or UAVs including UE/UAV 602). The request 628 may be associated with a one or more components of the CN 606, such as an AMF or LMF. The request may include one or more IDs of the particular UE or UAV or the set of UEs and/or UAVs.

In some aspects, based on the request 628, the UAS-NF may, at 630, identify stored information relevant to the request 628 and convert the stored information (to a format associated with the request 628). The stored information identified at 630 may be based on one or more of FP information 616 received from the CN 606 or FP information 622 received from the USS 610. The UAS-NF 607 may then transmit, to CN 606 (e.g., to an AMF or LMF associated with the request 628), FP information 632 based on the information stored by the UAS-NF 607. The CN 606 may then transmit the FP information 634 to the RAN 604 and the RAN 604 may, in turn, transmit FP information 636 to the UE/UAV 602. In some aspects, the CN 606 and/or the RAN 604 may additionally, or alternatively, transmit FP information based on FP information 632 and/or 634 to one or more UEs and/or UAVs for which the requested FP information is relevant (e.g., a set of one or more UEs or UAVs in a same location or area).

FIG. 7 is a call flow diagram 700 illustrating a FP information storage and retrieval function of FP information authorization and/or FP information verification function in an environment in accordance with some aspects of the disclosure. A UE/UAV 702, in some aspects, may transmit FP information 712 to an associated RAN 704 (e.g., a NG-RAN). The UE/UAV 702, in some aspects, may be a UE, a UAV, a drone, or other component of the RAN 704. The FP information 712 provided, in some aspects, by the UE/UAV 702 may indicate and/or identify a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. The sequence of waypoints, in some aspects, may be associated with a set of timestamps (e.g., a sequence of timestamps corresponding to the sequence of waypoints). The set of timestamps, in some aspects, may include one or more of absolute timestamps (e.g., timestamps expressed in relation to a global or shared reference frame) or a relative time (e.g., a timestamp expressed in relation to a local time kept at the UE/UAV 702 or in relation to a beginning or ending waypoint of a FP). The FP information 712 may also include at least one ID of the UE/UAV 702. The at least one ID, in some aspects, may be one of a GPSI or a SUPI. The FP information 712, in some aspects, may be provided in a first format associated with the UE/UAV 702 or the RAN 704.

The RAN 704, in some aspects, may then provide the FP information 714 (e.g., the FP information 712 provided by the UE/UAV 702) to a core network (CN) 706 (e.g., an AMF). The CN 706 may transmit FP information 716 to UAS-NF 707 via Nnef 708 (e.g., an interface provided by the UAS-NF or a FP server implemented within the UAS-NF). The FP information 716, in some aspects, may include an indication (e.g., a function call such as “Nnef_FlightInfoStore”) to store second information regarding the flightpath of the UE/UAV 702. The UAS-NF 707 (or the FP server implemented by the UAS-NF 707) may, if the first format is not the same as a format used by the UAS-NF 707, convert at 718 the FP information 716 received in the first format into a second format used to store at 720 FP information in the UAS-NF (or FP server). In some aspects, the UAS-NF 707 may not convert the FP information 716 if the first format is the same as the second format used to store FP information at the UAS-NF. Alternatively, or additionally, the UAS-NF 707 may not convert the FP information 716 from the first format to the second format and, in some aspects, may store the FP information 716 in the first format along with an indication that the FP information is stored in the first format.

The CN 706 may transmit, and UAS-NF 707 may receive, a request 722 for FP information subsequently received by the UAS-NF 707 (e.g., via a function call “Nnef_FlightInfoRetrieve_notification” or “Nnef_FlightPathInfoStore_notification” for updates to FP information) relating to a particular UE or UAV or a set of UEs and/or UAVs (e.g., one or more UEs or UAVs including UE/UAV 702). The request 722 may be associated with a one or more components of the CN 706, such as an AMF or LMF. The request may include one or more IDs of the particular UE or UAV or the set of UEs and/or UAVs.

In some aspects, the UAS-NF 707 may additionally receive FP information 724 from a USS 710 (or some other external server) via Naf 709. The FP information 724 may indicate FP information associated with one or more UEs or UAVs, e.g., including UE/UAV 702 or other UEs or UAVs associated with the UAS-NF 707 or the CN 706. The FP information, in some aspects, may be transmitted in a third format that is the same as, or different from, the first and second formats. The FP information 724, in some aspects, may be associated with authorization or verification operations performed by the USS 710 and/or the UAS-NF 707. In some aspects, the FP information 724 may include FP information for UEs and/or UAVs not associated with the CN 706 or the RAN 704 but operating in a same location or area as one or more UEs or UAVs associated with the CN 706 or the RAN 704.

The UAS-NF 707 may, in some aspects, convert the FP information 724 received from the USS 710 into the second format and may store the FP information 724. As for the FP information 716, in some aspects, the FP information 724 may be stored in the third format in which it was received with an indication of the format for conversion at a later time. In some aspects, based on the request 722, the UAS-NF may, at 726, identify stored information relevant to the request 722 and convert the stored information (to a format associated with the request 722). The stored information identified at 726 may be based on one or more of FP information 716 received from the CN 706 or FP information 724 received from the USS 710. The UAS-NF 707 may then transmit, to CN 706 (e.g., to an AMF or LMF associated with the request 722), FP information 728 based on the information stored by the UAS-NF 707. The CN 706 may then transmit the FP information 730 to the RAN 704 and the RAN 704 may, in turn, transmit FP information 732 to the UE/UAV 702. In some aspects, the CN 706 and/or the RAN 704 may additionally, or alternatively, transmit FP information based on FP information 728 and/or 730 to one or more UEs and/or UAVs for which the requested FP information is relevant (e.g., a set of one or more UEs or UAVs in a same location or area).

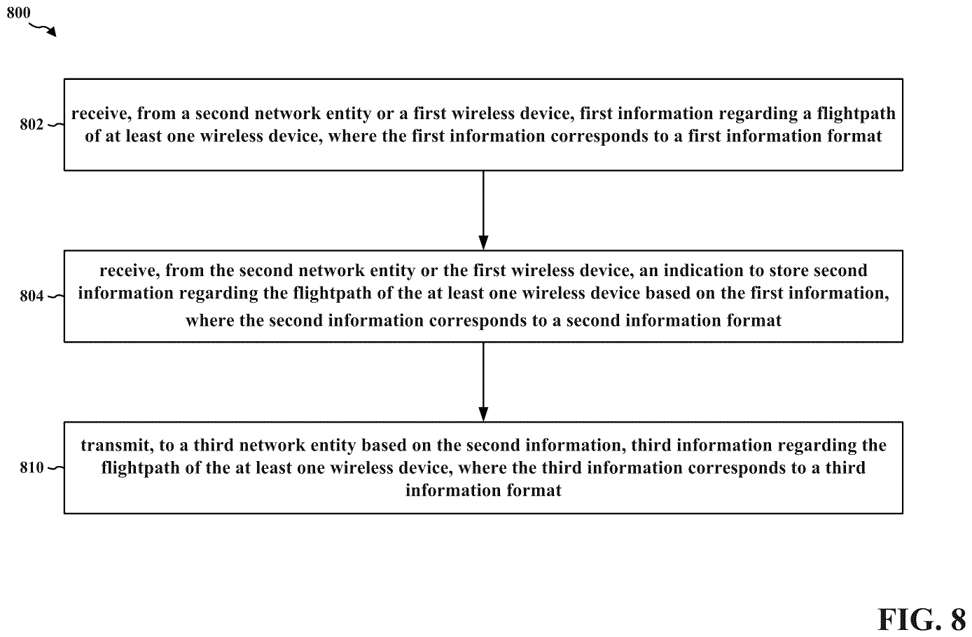

FIG. 8 is a diagram 800 illustrating components of a system including a UAS-NF 810 implementing FP server 812 interacting with an external server, USS 820, and core network 830 associated with a NG-RAN 840 and at least one UE/UAV 850 in accordance with some aspects of the disclosure. As described in relation to FIGS. 5-7, the UAS-NF 810 may receive FP information from a core network via, or in association with, a function call such as “Nnef_FlightInfoStore” 833 provided (or exposed) by an interface (Nnef) 816. The FP information, in some aspects, may be received at the core network 830 via the RAN 840 from one or more UEs or UAVs including the UE/UAV 850. The core network 830 (e.g., a component of the core network such as an AMF or LMF) may transmit additional function calls and/or requests to the USA-NF 810 such as “Nnef_FlightPathInfoRetrieve” 834 for retrieving stored information from the UAS-NF 810 and more specifically FP server 812, or “Nnef_FlightPathInfoStore_notification” 835 and/or “Nnef_FlightInfoRetrieve_notification” 836, for requesting notifications regarding updates to the FP information for one or more UEs or UAVs. The core network 830 may receive FP information or an FP information update from the UAS-NF 810 as described in relation to FP information 632 of FIG. 6 and FP information 728 of FIG. 7.

The UAS-NF 810 may further interact with an external server, USS 820 via an interface, Naf 818. For example, the UAS-NF may receive FP information 822 from USS 820 via Naf 818. Additionally, the UAS-NF 810 may transmit a verification request 824, e.g., “Naf_FlightPathInfoVerify”, to USS 820 and receive verification information 826 in response. In some aspects, the UAS-NF 810 and the USS 820 may alternatively, or additionally, exchange an authorization request and an authorization.

As illustrated the FP server 812 may include an FP information database 814 that may include data structures for storing FP information. While described as a database FP information database 814 may be implemented as different data structures for storing and/or organizing data in different aspects. A first data structure Nnef_FlightPathInfo 860 may include information including UAV info 861 (e.g., an identifier such as a GPSI or SUPI), FP information 862 indicating a set of waypoints, a format indication 863 indicating a format of the FP information 862, timestamp(s) 864 indicating a set of timestamps (objective or relative timestamps) associated with the FP information 862 (e.g., waypoints in the set of FP information 862), and a result 865 (e.g., a result of an authorization or verification operation). A second data structure Naf_FlightPathInfo 870 may include information including UAV info 871 (e.g., an identifier such as a GPSI, a SUPI, or a CAA-level UAV ID), FP information 872 indicating a set of waypoints, a format indication 873 indicating a format of the FP information 872, timestamp(s) 874 indicating a set of timestamps (objective or relative timestamps) associated with the FP information 872 (e.g., waypoints), and a result 875 (e.g., a result of an authorization or verification operation).

The waypoints indicated in FP information 862 or FP information 872 via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. The format indication 863 or 873 may indicate which of methods of indicating the waypoints is used for associated FP information. In some aspects, FP information for different UEs or UAVs may be stored in different formats in a same data structure (e.g., Nnef_FlightPathInfo 860 or Naf_FlightPathInfo 870). In some aspects, FP information for a same UE or UAV may be stored in different formats in different data structures (e.g., Nnef_FlightPathInfo 860 or Naf_FlightPathInfo 870). Data entries in one or more data structures of the FP information database 814, in some aspects, may be associated with an indication of a time associated with the reception or storage of the FP information associated with the data entries. The indicated time, in some aspects, may be used to determine which of multiple data entries associated with a same UE or UAV in one or more data structures is a most recent (e.g., a most up-to-date or current). In some aspects, the source of the FP information may be associated with a data entry in the one or more data structures and the source identifier may alternatively, or additionally, be used to determine a precedence and/or authoritativeness of conflicting data entries for a same UE or UAV.

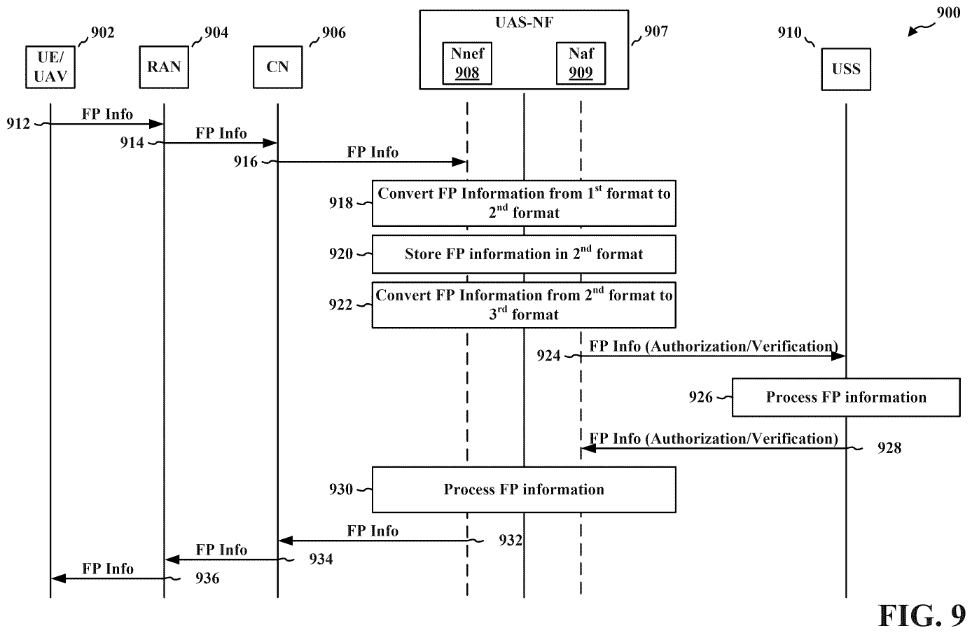

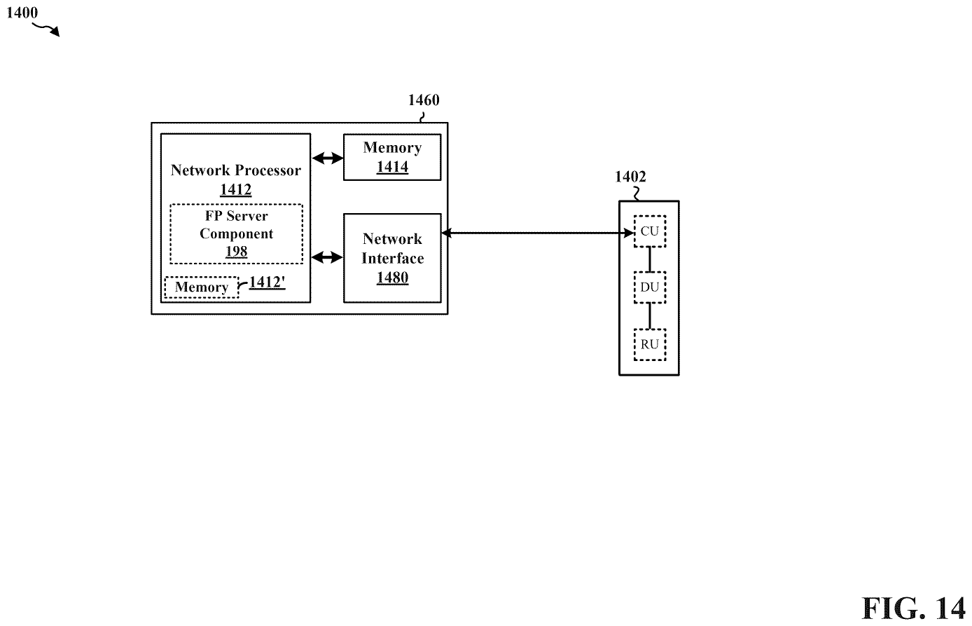

FIG. 9 is a flowchart 900 of a method of wireless communication. The method may be performed by a UAS-NF or a FP server implemented by a UAS-NF (e.g., the UAS 167; the UAS-NF 507, 607, 707, or 810; the network entity 1460). At 902, the FP server may receive, from a second network entity or a first wireless device, first information regarding a flightpath of at least one wireless device. For example, 902 may be performed by network interface 1480, network processor 1412, or FP server component 198 of FIG. 14. In some aspects, the second network entity may be a component (e.g., an AMF) of a core network associated with both the at least one wireless device and the first network entity (e.g., the FP server or UAS-NF implementing the FP server). In some aspects, the UAS-NF or the FP server may be implemented as a function of the core network.

In some aspects, the first information may correspond to a first information format. The first information may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. A set of waypoints in the sequence of waypoints, in some aspects, may be associated with a set of timestamps and the set of timestamps may include one or more of an absolute time or a relative time. The at least one wireless device, in some aspects, may be the first wireless device. In some aspects, the at least one wireless device may be at least one of a UAV, a drone, or a UE. The first information regarding the flightpath of the at least one wireless device, in some aspects, may include at least one ID of the at least one wireless device. The at least one ID, in some aspects, may be one of a GPSI, a SUPI, or a CAA-level ID (e.g., an ID previously assigned to the UE or UAV by a USS or UTM). For example, referring to FIGS. 5-7, the UAS-NF 507, 607, or 707 may receive FP information 516, 616, or 716 from a CN 506, 606, or 706 (based on FP information 512, 612, or 712, or FP information 514, 614, or 714 transmitted by a UE/UAV 502, 602, or 702 or by a RAN 504, 604, or 704).

At 904, the FP server may receive an indication to store second information regarding the flightpath of the at least one wireless device based on the first information. For example, 904 may be performed by network interface 1480, network processor 1412, or FP server component 198 of FIG. 14. The FP server, in some aspects, may receive the indication to store the second information along with the first information received at 902. The second information, in some aspects, corresponds to the second information format. Referring to FIGS. 5-8, the UAS-NF 507, 607, 707, or 810 may receive an indication to store the FP information 516, 616, 716, or 831 as part of receiving FP information 516, 616, 716, or 831 (e.g., Nnef_FlightPathInfoStore 833 may include the FP information 831).

The FP server may convert the first information in the first information format into second information in the second information format for storage. In some aspects, information formats may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. If the first information format is the same as the second information format, the FP may not convert the first information. For example, referring to FIGS. 5-7, the UAS-NF 507, 607, or 707 may convert, at 518, 618, or 718, FP information 516, 616, or 716 from a first information format to a second information format.

The FP server, may further convert the second information in the second information format into third information in the third information format. In some aspects, different information formats may be associated with different methods of identifying a sequence of waypoints, a starting (or takeoff) location, and/or a destination (or landing) location. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. If the third information format is the same as the second information format, the FP may not convert the second information. For example, referring to FIGS. 5-7, the UAS-NF 507, 607, or 707 may convert, at 522, 624, or 726, FP information stored by the UAS-NF 597, 607, or 707 from a second information format to a third information format.

At 910, the FP server may transmit, to a third network entity based on the second information, the third information regarding the flightpath of the at least one wireless device. For example, 910 may be performed by network interface 1480, network processor 1412, or FP server component 198 of FIG. 14. In some aspects, the third information corresponds to a third information format. At least two of the first information format, the second information format, or the third information format, in some aspects, may be different information formats. In some aspects, the third information may be transmitted to the third network entity in a verification request for verification of the third information regarding the flightpath of the at least one wireless device. The third entity, in some aspects, may be a USS providing authentication and/or verification services. In some aspects, the third information may be transmitted to the third network entity in an authorization request for authorization for the flightpath of the at least one wireless device included in the third information. For example, referring to FIGS. 5 and 8, the UAS-NF 507 or 810 may transmit FP information 524 as part of a verification request associated with the FP information 524 or as part of a verification request 824 based on information 516.

The FP server may receive, in response to transmitting the third information, verification information from the third network entity. For example, 912 may be performed by network interface 1480, network processor 1412, or FP server component 198 of FIG. 14. In some aspects, the verification information may indicate whether the third information is consistent with fourth flightpath information regarding the flightpath of the at least one wireless device at the third network entity (e.g., fourth FP information stored at the third entity). In some aspects, the verification information may include an authorization indication indicating whether the flightpath of the at least one wireless device included in the third flightpath information has been authorized by the third network entity or a fourth entity (e.g., a CAA) associated with the third network entity. For example, referring to FIGS. 5 and 8, the UAS-NF 507 or 810 may receive FP information 528 or verification information 826 including verification and/or authorization information based on the FP information 524 associated with a verification and/or authorization request.

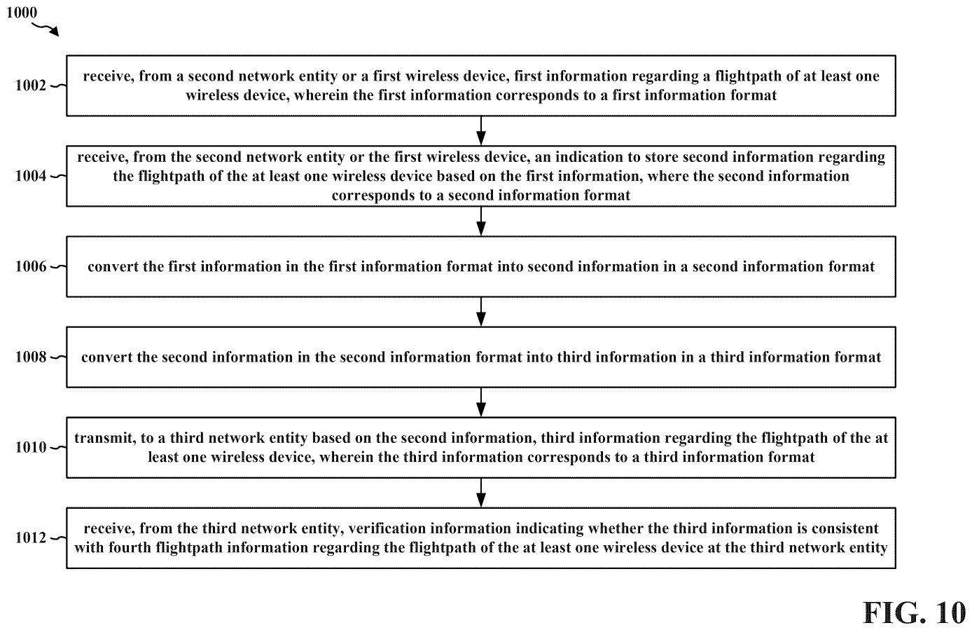

FIG. 10 is a flowchart 1000 of a method of wireless communication. The method may be performed by a UAS-NF or a FP server implemented by a UAS-NF (e.g., the UAS 167; the UAS-NF 507, 607, 707, or 810; the network entity 1460). At 1002, the FP server may receive, from a second network entity or a first wireless device, first information regarding a flightpath of at least one wireless device. For example, 1002 may be performed by network interface 1480, network processor 1412, or FP server component 198 of FIG. 14. In some aspects, the second network entity may be a component (e.g., an AMF) of a core network associated with both the at least one wireless device and the first network entity (e.g., the FP server or UAS-NF implementing the FP server). In some aspects, the UAS-NF or the FP server may be implemented as a function of the core network.

In some aspects, the first information may correspond to a first information format. The first information may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. A set of waypoints in the sequence of waypoints, in some aspects, may be associated with a set of timestamps and the set of timestamps may include one or more of an absolute time or a relative time. The at least one wireless device, in some aspects, may be the first wireless device. In some aspects, the at least one wireless device may be at least one of a UAV, a drone, or a UE. The first information regarding the flightpath of the at least one wireless device, in some aspects, may include at least one ID of the at least one wireless device. The at least one ID, in some aspects, may be one of a GPSI, a SUPI, or a CAA-level ID (e.g., an ID previously assigned to the UE or UAV by a USS or UTM). For example, referring to FIGS. 5-7, the UAS-NF 507, 607, or 707 may receive FP information 516, 616, or 716 from a CN 506, 606, or 706 (based on FP information 512, 612, or 712, or FP information 514, 614, or 714 transmitted by a UE/UAV 502, 602, or 702 or by a RAN 504, 604, or 704).

At 1004, the FP server may receive an indication to store second information regarding the flightpath of the at least one wireless device based on the first information. For example, 1004 may be performed by network interface 1480, network processor 1412, or FP server component 198 of FIG. 14. The FP server, in some aspects, may receive the indication to store the second information along with the first information received at 1002. The second information, in some aspects, corresponds to the second information format. Referring to FIGS. 5-8, the UAS-NF 507, 607, 707, or 810 may receive an indication to store the FP information 516, 616, 716, or 831 as part of receiving FP information 516, 616, 716, or 831 (e.g., Nnef_FlightPathInfoStore 833 may include the FP information 831).

At 1006, the FP server may convert the first information in the first information format into second information in the second information format for storage. For example, 1006 may be performed by network processor 1412 or FP server component 198 of FIG. 14. In some aspects, information formats may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. If the first information format is the same as the second information format, the FP may not convert the first information at 1006. For example, referring to FIGS. 5-7, the UAS-NF 507, 607, or 707 may convert, at 518, 618, or 718, FP information 516, 616, or 716 from a first information format to a second information format.

At 1008, the FP server, may convert the second information in the second information format into third information in the third information format. For example, 1008 may be performed by network processor 1412 or FP server component 198 of FIG. 14. In some aspects, information formats may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. If the third information format is the same as the second information format, the FP may not convert the second information at 1008. For example, referring to FIGS. 5-7, the UAS-NF 507, 607, or 707 may convert, at 522, 624, or 726, FP information stored by the UAS-NF 597, 607, or 707 from a second information format to a third information format.

At 1010, the FP server may transmit, to a third network entity based on the second information, the third information regarding the flightpath of the at least one wireless device. For example, 1010 may be performed by network interface 1480, network processor 1412, or FP server component 198 of FIG. 14. In some aspects, the third information corresponds to a third information format. At least two of the first information format, the second information format, or the third information format, in some aspects, may be different information formats. In some aspects, the third information may be transmitted to the third network entity in a verification request for verification of the third information regarding the flightpath of the at least one wireless device. The third entity, in some aspects, may be a USS providing authentication and/or verification services. In some aspects, the third information may be transmitted to the third network entity in an authorization request for authorization for the flightpath of the at least one wireless device included in the third information. For example, referring to FIGS. 5 and 8, the UAS-NF 507 or 810 may transmit FP information 524 as part of a verification request associated with the FP information 524 or as part of a verification request 824 based on information 516.

Finally, at 1012, the FP server may receive from the third network entity, verification information. For example, 1012 may be performed by network interface 1480, network processor 1412, or FP server component 198 of FIG. 14. In some aspects, the verification information may indicate whether the third information is consistent with fourth flightpath information regarding the flightpath of the at least one wireless device at the third network entity (e.g., fourth FP information stored at the third entity). In some aspects, the verification information may include an authorization indication indicating whether the flightpath of the at least one wireless device included in the third flightpath information has been authorized by the third network entity or a fourth entity (e.g., a CAA) associated with the third network entity. For example, referring to FIGS. 5 and 8, the UAS-NF 507 or 810 may receive FP information 528 or verification information 826 including verification and/or authorization information based on the FP information 524 associated with a verification and/or authorization request.

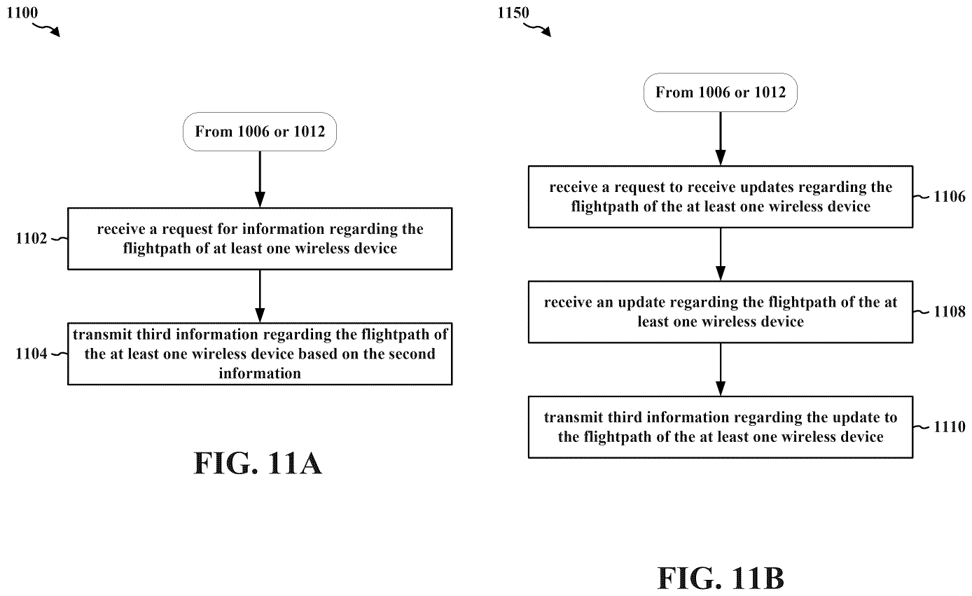

In some aspects, in addition to receiving and storing the first flightpath information from the first entity, the FP server may expose additional functions for the first entity (e.g., a component of a core network such as an AMF and/or a LMF). The additional functions may relate to retrieving stored information or subscribing for updates relating to at least one UE or UAV associated with the core network. FIG. 11A is a flowchart 1100 of a method of wireless communication. The method may be performed by the UAS-NF or a FP server implemented by a UAS-NF performing the method of wireless communication illustrated in flowchart 1000 (e.g., the UAS 167; the UAS-NF 507, 607, 707, or 810; the network entity 1460). The flowchart 1100, in some aspects, may follow 1006 or 1012 of flowchart 1000. At 1102, the FP server may receive a request for information regarding the flightpath of the at least one wireless device. For example, 1102 may be performed by network interface 1480, network processor 1412, or FP server component 198 of FIG. 14. The request for the information regarding the flightpath of the at least one wireless device, in some aspects, may be received from the second network entity (e.g., the AMF) that provided the first flightpath information or from a fourth network entity (e.g., an LMF). The request, in some aspects, may indicate an ID associated with the at least one wireless device (e.g., the GPSI, SUPI, or CAA-level ID) and may further indicate a flightpath information format. For example, referring to FIGS. 6 and 8, the CN 606 or core network 830 (or a component of the CN 606 or core network 830 such as an AMF or LMF) may transmit, and UAS-NF 607 or 810 may receive, FP information request 628 (e.g., “Nnef_FlightPathInfoRetrieve”).

At 1104, the FP server may transmit third information regarding the flightpath of the at least one wireless device based on the second information (e.g., the information stored at the FP server). For example, 1104 may be performed by network interface 1480, network processor 1412, or FP server component 198 of FIG. 14. The third information may be identified based on an ID associated with the at least one wireless device. For example, referring to FIGS. 6 and 8, the UAS-NF 607 or 810 may transmit FP information 632 stored by the UAS-NF 607 or 810.

FIG. 11B is a flowchart 1150 of a method of wireless communication. The method may be performed by the UAS-NF or a FP server implemented by a UAS-NF performing the method of wireless communication illustrated in flowchart 1000 (e.g., the UAS 167; the UAS-NF 507, 607, 707, or 810; the network entity 1460). The flowchart 1150, in some aspects, may follow 1006 or 1012 of flowchart 1000. At 1106, the FP server may receive a request to receive updates regarding the flightpath of the at least one wireless device. For example, 1106 may be performed by network interface 1480, network processor 1412, or FP server component 198 of FIG. 14. The request for the information regarding the flightpath of the at least one wireless device, in some aspects, may be received from the second network entity (e.g., the AMF) that provided the first flightpath information or from a fourth network entity (e.g., an LMF). The request, in some aspects, may indicate an ID associated with the at least one wireless device (e.g., the GPSI, SUPI, or CAA-level ID) and may further indicate a flightpath information format. For example, referring to FIGS. 7 and 8, the CN 706 or core network 830 (or a component of the CN 706 or core network 830 such as an AMF or LMF) may transmit, and UAS-NF 707 or 810 may receive request 722 (e.g., a function call “Nnef_FlightPathInfoStore_notification” 835 that may be associated with an AMF or a function call “Nnef_FlightPathInfoRetrieve_notification” 836 that may be associated with one or more of an AMF or a LMF).

At 1108, the FP server may receive updated flightpath information from a network entity that did not transmit the request (but may have sent a separate request for a same or different UE or UAV ID). For example, 1108 may be performed by network interface 1480, network processor 1412, or FP server component 198 of FIG. 14. The updated flightpath information may have a higher priority than previously stored flightpath information based on a source or a timing. The updated flightpath information, in some aspects, may be based on a UAV management operation performed at, or by, the network entity from which the updated flightpath information was received at 1108. The updated flightpath information may be received in a third flightpath information format. For example, referring to FIGS. 7 and 8, the UAS-NF 707 or 810 may receive FP information 724 or 822 from USS 710 or 820.

At 1110, the FP server may transmit third information regarding the flightpath of the at least one wireless device based on the updated flightpath information received at 1108 (e.g., the updated information stored at the FP server). For example, 1110 may be performed by network interface 1480, network processor 1412, or FP server component 198 of FIG. 14. The third information may be identified based on an ID associated with the at least one wireless device. For example, referring to FIGS. 6 and 8, the UAS-NF 707 or 810 may transmit FP information 728 stored by the UAS-NF 607 or 810 based on receiving updated FP information 724 or FP information 822.

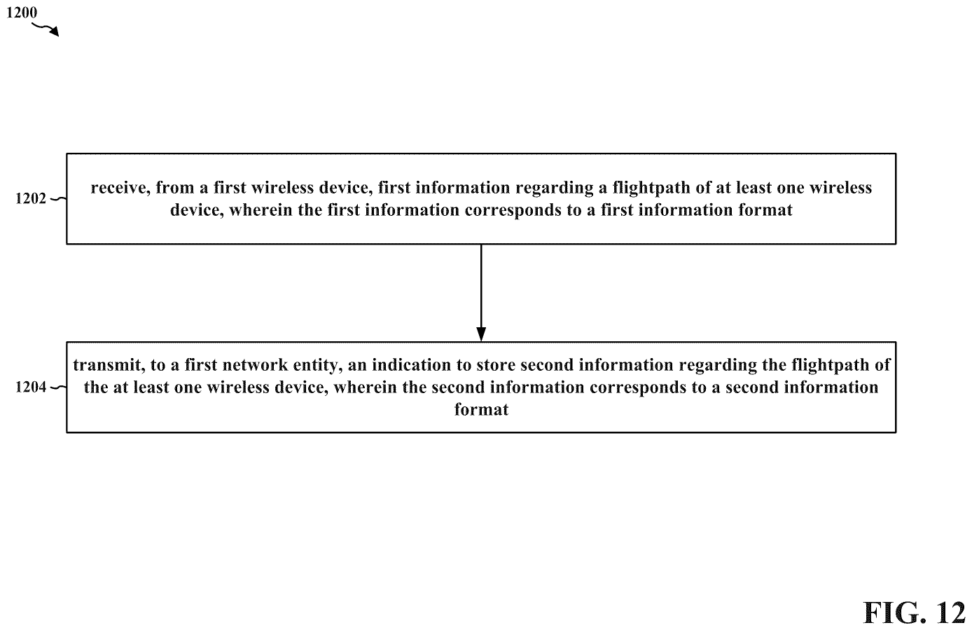

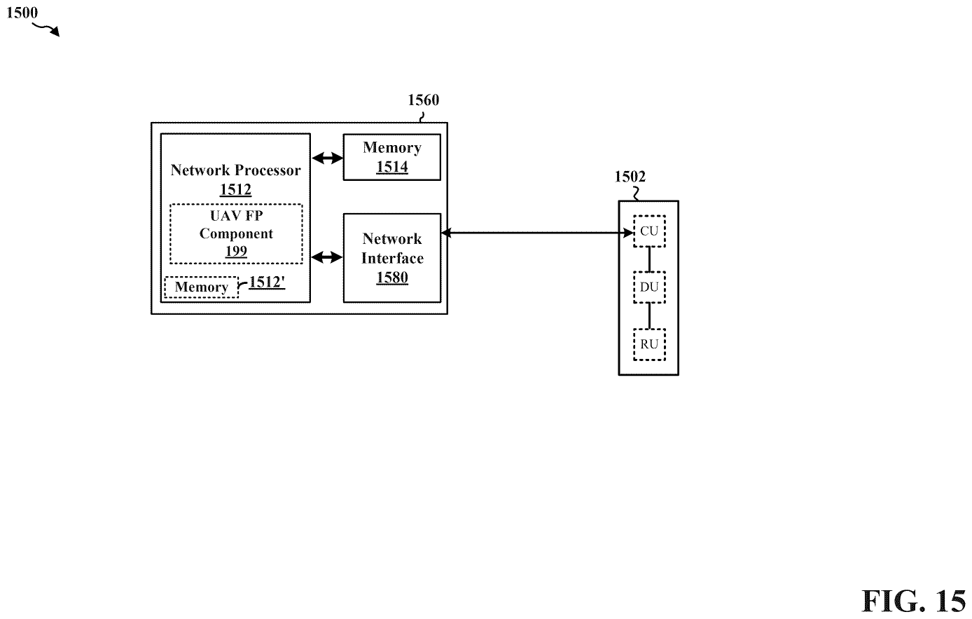

FIG. 12 is a flowchart 1200 of a method of wireless communication. The method may be performed by a core network or a core network component such as an AMF (e.g., the AMF 161; the CN 506, 606, 706, or core network 830; the network entity 1560). At 1202, the AMF may receive, from a first wireless device, first information regarding a flightpath of at least one wireless device. For example, 1202 may be performed by network interface 1580, network processor 1512, or FP server component 198 of FIG. 15. In some aspects, the first information may correspond to a first information format. The first information may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. A set of waypoints in the sequence of waypoints, in some aspects, may be associated with a set of timestamps and the set of timestamps may include one or more of an absolute time or a relative time.

The at least one wireless device, in some aspects, may be the first wireless device. In some aspects, the at least one wireless device may be at least one of a UAV, a drone, or a UE. The first information regarding the flightpath of the at least one wireless device, in some aspects, may include at least one ID of the at least one wireless device. The at least one ID, in some aspects, may be one of a GPSI, a SUPI, or a CAA-level ID (e.g., an ID previously assigned to the UE or UAV by a USS or UTM). For example, referring to FIGS. 5-7, the CN 506, 606, or 706 may receive FP information 514, 614, or 714 (based on FP information 512, 612, or 712 transmitted by a UE/UAV 502, 602, or 702) from a RAN 504, 604, or 704.

At 1204, the AMF may transmit, to a first network entity, an indication to store second information regarding the flightpath of the at least one wireless device. For example, 1204 may be performed by network interface 1580, network processor 1512, or FP server component 198 of FIG. 15. The first network entity in some aspects, may be an FP server or a UAS-NF implementing the FP server. The first network entity, in some aspects, may expose a network function and/or interface to receive function calls including a function call for FP information storage (e.g., a Nnef_FlightPathInfoStore function call). In some aspects, the UAS-NF or the FP server may be implemented as a function of the core network. The second information, in some aspects, may correspond to a second information format for indicating the waypoints. In some aspects, the first information format may be different from the second information format and a conversion may be performed by the first network entity. However, if the first information format is the same as the second information format, the FP may not convert the first information. For example, referring to FIGS. 5-7, the CN 506, 606, or 706 may transmit FP information 516, 616, or 716 that may include a request to store the second information.

In some aspects, a UAS-NF may expose functions for flightpath information retrieval and the AMF may transmit a request for information regarding the flightpath of the at least one wireless device. The request for the information regarding the flightpath of the at least one wireless device, in some aspects, may be transmitted to the first network entity. The request, in some aspects, may indicate an ID associated with the at least one wireless device (e.g., the GPSI, SUPI, or CAA-level ID) and may further indicate a flightpath information format. For example, referring to FIGS. 6 and 8, the CN 606 or core network 830 (or a component of the CN 606 or core network 830 such as an AMF) may transmit, and UAS-NF 607 or 810 may receive, FP information request 628 (e.g., “Nnef_FlightPathInfoRetrieve”).

The AMF may receive, in response to transmitting the request, third information regarding the flightpath of the at least one wireless device based on the second information (e.g., the information stored at the FP server). For example, 1208 may be performed by network interface 1580, network processor 1512, or FP server component 198 of FIG. 15. The third information may be identified based on an ID associated with the at least one wireless device. For example, referring to FIGS. 6 and 8, the CN 606 or the core network 830 may receive, and UAS-NF 607 or 810 may transmit, FP information 632 stored by the UAS-NF 607 or 810.

In some aspects, a UAS-NF may expose functions for flightpath information updates and the AMF may transmit a request to receive updates regarding the flightpath of the at least one wireless device. The request for the information regarding the flightpath of the at least one wireless device, in some aspects, may be transmitted to the first network entity. The request, in some aspects, may indicate an ID associated with the at least one wireless device (e.g., the GPSI, SUPI, or CAA-level ID) and may further indicate a flightpath information format. For example, referring to FIGS. 7 and 8, the CN 706 or core network 830 (or a component of the CN 706 or core network 830 such as an AMF) may transmit, and UAS-NF 707 or 810 may receive, request 722 (e.g., a function call “Nnef_FlightPathInfoStore_notification” 835 that may be associated with an AMF or a function call “Nnef_FlightPathInfoRetrieve_notification” 836 that may be associated with the AMF).

The FP server may receive updated flightpath information from a network entity that did not transmit the request (but may have sent a separate request for a same or different UE or UAV ID). The updated flightpath information may have a higher priority than previously stored flightpath information based on a source or a timing. The updated flightpath information, in some aspects, may be based on a UAV management operation performed at, or by, the network entity from which the updated flightpath information was received. The updated flightpath information may be received in a fourth flightpath information format. For example, referring to FIGS. 7 and 8, the UAS-NF 707 or 810 may receive FP information 724 or 822 from USS 710 or 820.

The AMF may, in response to transmitting the request to receive updates, receive fourth information regarding the flightpath of the at least one wireless device based on the updated flightpath information received by the first network entity (e.g., the updated information stored at the FP server). For example, 1212 may be performed by network interface 1580, network processor 1512, or FP server component 198 of FIG. 15. The fourth information may be identified based on an ID associated with the at least one wireless device. For example, referring to FIGS. 6 and 8, the CN 706 and the core network 830 may receive, and UAS-NF 707 or 810 may transmit, FP information 728 stored by the UAS-NF 607 or FP information update 832 stored by UAS-NF 810 based on receiving updated FP information 724 or FP information 822.

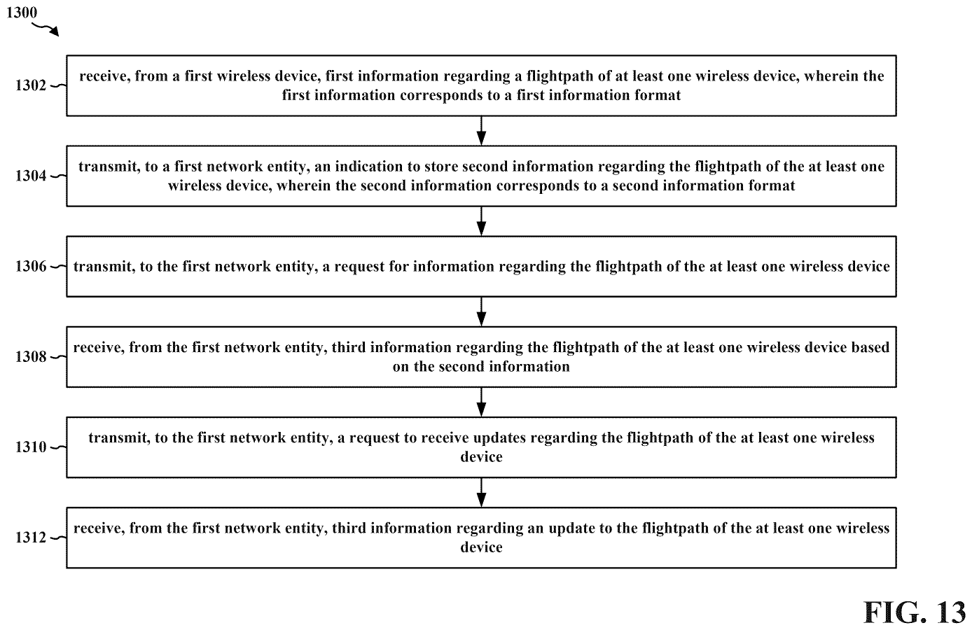

FIG. 13 is a flowchart 1300 of a method of wireless communication. The method may be performed by a core network or a core network component such as an AMF (e.g., the AMF 161; the CN 506, 606, 706, or core network 830; the network entity 1560). At 1302, the AMF may receive, from a first wireless device, first information regarding a flightpath of at least one wireless device. For example, 1302 may be performed by network interface 1580, network processor 1512, or FP server component 198 of FIG. 15. In some aspects, the first information may correspond to a first information format. The first information may be associated with an identification of a sequence of waypoints. The sequence of waypoints, in some aspects, may be represented in one or more GADs. In some aspects, the waypoints may be indicated, e.g., for a UMTS, via one or more of an ellipsoid point, an ellipsoid point with uncertainty circle, an ellipsoid point with an uncertainty ellipse, a polygon, an ellipsoid point with altitude, an ellipsoid point with altitude and an uncertainty ellipsoid, or an ellipsoid arc. A set of waypoints in the sequence of waypoints, in some aspects, may be associated with a set of timestamps and the set of timestamps may include one or more of an absolute time or a relative time.

The at least one wireless device, in some aspects, may be the first wireless device. In some aspects, the at least one wireless device may be at least one of a UAV, a drone, or a UE. The first information regarding the flightpath of the at least one wireless device, in some aspects, may include at least one ID of the at least one wireless device. The at least one ID, in some aspects, may be one of a GPSI, a SUPI, or a CAA-level ID (e.g., an ID previously assigned to the UE or UAV by a USS or UTM). For example, referring to FIGS. 5-7, the CN 506, 606, or 706 may receive FP information 514, 614, or 714 (based on FP information 512, 612, or 712 transmitted by a UE/UAV 502, 602, or 702) from a RAN 504, 604, or 704.

At 1304, the AMF may transmit, to a first network entity, an indication to store second information regarding the flightpath of the at least one wireless device. For example, 1304 may be performed by network interface 1580, network processor 1512, or FP server component 198 of FIG. 15. The first network entity in some aspects, may be an FP server or a UAS-NF implementing the FP server. The first network entity, in some aspects, may expose a network function and/or interface to receive function calls including a function call for FP information storage (e.g., a Nnef_FlightPathInfoStore function call). In some aspects, the UAS-NF or the FP server may be implemented as a function of the core network. The second information, in some aspects, may correspond to a second information format for indicating the waypoints. In some aspects, the first information format may be different from the second information format and a conversion may be performed by the first network entity. However, if the first information format is the same as the second information format, the FP may not convert the first information. For example, referring to FIGS. 5-7, the CN 506, 606, or 706 may transmit FP information 516, 616, or 716 that may include a request to store the second information.

At 1306, the AMF may transmit a request for information regarding the flightpath of the at least one wireless device. For example, 1306 may be performed by network interface 1580, network processor 1512, or FP server component 198 of FIG. 15. The request for the information regarding the flightpath of the at least one wireless device, in some aspects, may be transmitted to the first network entity. The request, in some aspects, may indicate an ID associated with the at least one wireless device (e.g., the GPSI, SUPI, or CAA-level ID) and may further indicate a flightpath information format. For example, referring to FIGS. 6 and 8, the CN 606 or core network 830 (or a component of the CN 606 or core network 830 such as an AMF) may transmit, and UAS-NF 607 or 810 may receive, FP information request 628 (e.g., “Nnef_FlightPathInfoRetrieve”).

At 1308, the AMF may receive third information regarding the flightpath of the at least one wireless device based on the second information (e.g., the information stored at the FP server). For example, 1308 may be performed by network interface 1580, network processor 1512, or FP server component 198 of FIG. 15. The third information may be identified based on an ID associated with the at least one wireless device. For example, referring to FIGS. 6 and 8, the CN 606 or the core network 830 may receive, and UAS-NF 607 or 810 may transmit, FP information 632 stored by the UAS-NF 607 or 810.

At 1310, the AMF may transmit a request to receive updates regarding the flightpath of the at least one wireless device. For example, 1310 may be performed by network interface 1580, network processor 1512, or FP server component 198 of FIG. 15. The request for the information regarding the flightpath of the at least one wireless device, in some aspects, may be transmitted to the first network entity. The request, in some aspects, may indicate an ID associated with the at least one wireless device (e.g., the GPSI, SUPI, or CAA-level ID) and may further indicate a flightpath information format. For example, referring to FIGS. 7 and 8, the CN 706 or core network 830 (or a component of the CN 706 or core network 830 such as an AMF) may transmit, and UAS-NF 707 or 810 may receive, request 722 (e.g., a function call “Nnef_FlightPathInfoStore_notification” 835 that may be associated with an AMF or a function call “Nnef_FlightPathInfoRetrieve_notification” 836 that may be associated with the AMF).

The FP server may receive updated flightpath information from a network entity that did not transmit the request (but may have sent a separate request for a same or different UE or UAV ID). The updated flightpath information may have a higher priority than previously stored flightpath information based on a source or a timing. The updated flightpath information, in some aspects, may be based on a UAV management operation performed at, or by, the network entity from which the updated flightpath information was received. The updated flightpath information may be received in a fourth flightpath information format. For example, referring to FIGS. 7 and 8, the UAS-NF 707 or 810 may receive FP information 724 or 822 from USS 710 or 820.

At 1312, the AMF may receive fourth information regarding the flightpath of the at least one wireless device based on the updated flightpath information received by the first network entity (e.g., the updated information stored at the FP server). For example, 1312 may be performed by network interface 1580, network processor 1512, or FP server component 198 of FIG. 15. The fourth information may be identified based on an ID associated with the at least one wireless device. For example, referring to FIGS. 6 and 8, the CN 706 and the core network 830 may receive, and UAS-NF 707 or 810 may transmit, FP information 728 stored by the UAS-NF 607 or FP information update 832 stored by UAS-NF 810 based on receiving updated FP information 724 or FP information 822.

FIG. 14 is a diagram 1400 illustrating an example of a hardware implementation for a network entity 1460. In one example, the network entity 1460 may be within the core network 120. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the FP server component 198 is configured to receive, from a second network entity or a first wireless device, first information regarding a flightpath of at least one wireless device, where the first information corresponds to a first information format; receive, from the second network entity or the first wireless device, an indication to store second information regarding the flightpath of the at least one wireless device based on the first information, where the second information corresponds to a second information format; and transmit, to a third network entity based on the second information, third information regarding the flightpath of the at least one wireless device, where the third information corresponds to a third information format. The FP server component 198 may be within the processor 1412. The FP server component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 includes means for receiving, from a second network entity or a first wireless device, first information regarding a flightpath of at least one wireless device. In one configuration, the network entity 1460 includes means for receiving, from the second network entity or the first wireless device, an indication to store second information regarding the flightpath of the at least one wireless device based on the first information. In one configuration, the network entity 1460 includes means for transmitting, to a third network entity based on the second information, third information regarding the flightpath of the at least one wireless device. In one configuration, the network entity 1460 includes means for converting, prior to storing the second information, the first information in the first information format into the second information in the second information format. In one configuration, the network entity 1460 includes means for converting, prior to transmitting the third information, the second information in the second information format into the third information in the third information format. In one configuration, the network entity 1460 includes means for receiving, from the third network entity, verification information indicating whether the third information is consistent with fourth flightpath information regarding the flightpath of the at least one wireless device at the third network entity. In one configuration, the network entity 1460 includes means for receiving, from one of the second network entity or a fourth network entity, a request for information regarding the flightpath of the at least one wireless device. In one configuration, the network entity 1460 includes means for transmitting, to at least one of the second network entity and the fourth network entity, fourth information regarding the flightpath of the at least one wireless device based on the second information. In one configuration, the network entity 1460 includes means for receiving, from the second network entity, a request to receive updates regarding the flightpath of the at least one wireless device. In one configuration, the network entity 1460 includes means for receiving, from one of the third network entity, the first wireless device, or a fourth network entity, fourth information including an update to the second information regarding the flightpath of the at least one wireless device. In one configuration, the network entity 1460 includes means for transmitting, to the second network entity, fifth information regarding the update to the second information regarding the flightpath of the at least one wireless device based on the fourth information. The means may be the FP server component of the network entity 1460 configured to perform the functions described in relation to FIGS. 9-11B and recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the UAV FP component 199 is configured to receive, from a first wireless device, first information regarding a flightpath of at least one wireless device, where the first information corresponds to a first information format; and transmit, to a first network entity, an indication to store second information regarding the flightpath of the at least one wireless device, where the second information corresponds to a second information format. The UAV FP component 199 may be within the processor 1512. The UAV FP component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 includes means for receiving, from a first wireless device, first information regarding a flightpath of at least one wireless device. In one configuration, the network entity 1560 includes means for transmitting, to a first network entity, an indication to store second information regarding the flightpath of the at least one wireless device. In one configuration, the network entity 1560 includes means for transmitting, to the first network entity, a request for information regarding the flightpath of the at least one wireless device. In one configuration, the network entity 1560 includes means for receiving, from the first network entity, third information regarding the flightpath of the at least one wireless device based on the second information. In one configuration, the network entity 1560 includes means for transmitting, to the first network entity, a request to receive updates regarding the flightpath of the at least one wireless device. In one configuration, the network entity 1560 includes means for receiving, from the first network entity, third information regarding an update to the flightpath of the at least one wireless device. The means may be the UAV FP component 199 of the network entity 1560 configured to perform the functions discussed in relation to FIGS. 12 and 13 and recited by the means.

In some aspects, a FP server may be implemented in the UAS-NF as discussed above. The FP server may store flightpath information received from a UAV or UE associated with a core network via a RAN and/or an AMF. The UAS-NF may additionally perform FP format conversion for FP information received in different formats from UAVs or UEs associated with the core network or from external servers. The FP server may provide interfaces and/or network functions for components of an associated core network and a set of external servers.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity including receiving, from a second network entity or a first wireless device, first information regarding a flightpath of at least one wireless device, where the first information corresponds to a first information format; receiving, from the second network entity or the first wireless device, an indication to store second information regarding the flightpath of the at least one wireless device based on the first information, where the second information corresponds to a second information format; and transmitting, to a third network entity based on the second information, third information regarding the flightpath of the at least one wireless device, where the third information corresponds to a third information format.

Aspect 2 is the method of aspect 1, where the first information is received in the first information format, the method further including converting, prior to storing the second information, the first information in the first information format into the second information in the second information format; and converting, prior to transmitting the third information, the second information in the second information format into the third information in the third information format.

Aspect 3 is the method of aspect 2, where at least two of the first information format, the second information format, or the third information format are different information formats, and where at least two of the first information format, the second information format, or the third information format are associated with an identification of a sequence of waypoints via one or more of a first ellipsoid point, a second ellipsoid point with an uncertainty circle, a third ellipsoid point with an uncertainty ellipse, a polygon, a fourth ellipsoid point with a first altitude, a fifth ellipsoid point with a second altitude and an uncertainty ellipsoid, or an ellipsoid arc.

Aspect 4 is the method of aspect 3, where a set of waypoints in the sequence of waypoints are associated with a set of timestamps, where the set of timestamps includes one or more of an absolute time or a relative time.

Aspect 5 is the method of any of aspects 1 to 4, where the first information regarding the flightpath of the at least one wireless device includes at least one ID of the at least one wireless device, where the at least one ID is one of a GPSI, a SUPI, or a CAA level ID.

Aspect 6 is the method of any of aspects 1 to 5, where the third information is transmitted to the third network entity in a verification request for verification of the third information regarding the flightpath of the at least one wireless device, the method further including receiving, from the third network entity, verification information indicating whether the third information is consistent with fourth flightpath information regarding the flightpath of the at least one wireless device at the third network entity.

Aspect 7 is the method of aspect 6, where the first network entity is an unmanned aerial vehicle administration server or an UAS-NF, where the second network entity is an AMF, where the first wireless device is a UE or a component in a RAN, and where the third network entity is a USS.

Aspect 8 is the method of any of aspects 1 to 7, where the at least one wireless device is at least one of an unmanned aerial vehicle, a drone, or a UE.

Aspect 9 is the method of any of aspects 1 to 8, further including receiving, from one of the second network entity or a fourth network entity, a request for fourth information regarding the flightpath of the at least one wireless device; and transmitting, to at least one of the second network entity and the fourth network entity, the fourth information regarding the flightpath of the at least one wireless device based on the second information.

Aspect 10 is the method of any of aspects 1 to 9, further including receiving, from the second network entity, a request to receive updates regarding the flightpath of the at least one wireless device; receiving, from one of the third network entity, the first wireless device, or a fourth network entity, fourth information including an update to the second information regarding the flightpath of the at least one wireless device; and transmitting, to the second network entity, fifth information regarding the update to the second information regarding the flightpath of the at least one wireless device based on the fourth information.

Aspect 11 is a method of wireless communication at a second network entity including receiving, from a first wireless device, first information regarding a flightpath of at least one wireless device, where the first information corresponds to a first information format; and transmitting, to a first network entity, an indication to store second information regarding the flightpath of the at least one wireless device, where the second information corresponds to a second information format.

Aspect 12 is the method of aspect 11, further including transmitting, to the first network entity, a request for third information regarding the flightpath of the at least one wireless device; and receiving, from the first network entity, the third information regarding the flightpath of the at least one wireless device based on the second information.

Aspect 13 is the method of any of aspects 11 or 12, further including transmitting, to the first network entity, a request to receive updates regarding the flightpath of the at least one wireless device; and receiving, from the first network entity, third information regarding an update to the flightpath of the at least one wireless device.

Aspect 14 is the method of any of aspects 11 to 13, where the first information format and the second information format are associated with an identification of a sequence of waypoints via one or more of a first ellipsoid point, a second ellipsoid point with an uncertainty circle, a third ellipsoid point with an uncertainty ellipse, a polygon, a fourth ellipsoid point with a first altitude, a fifth ellipsoid point with a second altitude and an uncertainty ellipsoid, or an ellipsoid arc.

Aspect 15 is the method of aspect 14, where the first information format and the second information format are different information formats.

Aspect 16 is the method of any of aspects 14 or 15, where a set of waypoints in the sequence of waypoints are associated with a set of timestamps, where the set of timestamps include one or more of an absolute time or a relative time.

Aspect 17 is the method of any of aspects 11 to 16, where the first information regarding the flightpath of the at least one wireless device includes at least one ID of the at least one wireless device, where the at least one ID is one of a GPSI, a SUPI, or a CAA level ID.

Aspect 18 is the method of any of aspects 11 to 17, where the first network entity is an unmanned aerial vehicle administration server or an UAS-NF, where the second network entity is an AMF, and where the first wireless device is a UE or a component in a RAN.

Aspect 19 is the method of any of aspects 11 to 18, where the at least one wireless device is at least one of an unmanned aerial vehicle, a drone, or a UE.

Aspect 20 is an apparatus for wireless communication at a device including a memory and at least one processor coupled to the memory and, based at least in part on information stored in the memory, the at least one processor is configured to implement any of aspects 1 to 19.

Aspect 21 is the method of aspect 20, further including a transceiver or an antenna coupled to the at least one processor.

Aspect 22 is an apparatus for wireless communication at a device including means for implementing any of aspects 1 to 19.

Aspect 23 is a computer-readable medium (e.g., a non-transitory computer-readable medium) storing computer executable code, where the code when executed by a processor causes the processor to implement any of aspects 1 to 19.

1. An apparatus for wireless communication at a first network entity, comprising:
a memory; and
at least one processor coupled to the memory and, based at least in part on information stored in the memory, the at least one processor is configured to:
receive, from a second network entity or a first wireless device, first information regarding a flightpath of at least one wireless device, wherein the first information corresponds to a first information format;
receive, from the second network entity or the first wireless device, an indication to store second information regarding the flightpath of the at least one wireless device based on the first information, wherein the second information corresponds to a second information format; and
transmit, to a third network entity based on the second information, third information regarding the flightpath of the at least one wireless device, wherein the third information corresponds to a third information format.

2. The apparatus of claim 1, wherein to receive the first information, wherein the at least one processor is configured to receive the first information in the first information format, and the at least one processor is further configured to:
convert, prior to the at least one processor being configured to store the second information, the first information in the first information format into the second information in the second information format; and
convert, prior to the at least one processor being configured to transmit the third information, the second information in the second information format into the third information in the third information format.

3. The apparatus of claim 2, wherein at least two of the first information format, the second information format, or the third information format are different information formats, and wherein at least two of the first information format, the second information format, or the third information format are associated with an identification of a sequence of waypoints via one or more of a first ellipsoid point, a second ellipsoid point with an uncertainty circle, a third ellipsoid point with an uncertainty ellipse, a polygon, a fourth ellipsoid point with a first altitude, a fifth ellipsoid point with a second altitude and an uncertainty ellipsoid, or an ellipsoid arc.

4. The apparatus of claim 3, wherein a set of waypoints in the sequence of waypoints are associated with a set of timestamps, wherein the set of timestamps comprises one or more of an absolute time or a relative time.

5. The apparatus of claim 1, wherein the first information regarding the flightpath of the at least one wireless device comprises at least one identifier (ID) of the at least one wireless device, wherein the at least one ID is one of a general public subscription identifier (GPSI), a subscription permanent identifier (SUP I), or a civilian aviation authority (CAA) level ID.

6. The apparatus of claim 1, wherein the at least one processor is configured to transmit the third information to the third network entity in a verification request for verification of the third information regarding the flightpath of the at least one wireless device, and the at least one processor is further configured to:
receive, from the third network entity, verification information indicating whether the third information is consistent with fourth flightpath information regarding the flightpath of the at least one wireless device at the third network entity.

7. The apparatus of claim 6, wherein the first network entity is an unmanned aerial vehicle administration server or an unmanned aircraft system network function (UAS-NF), wherein the second network entity is an access and mobility management function (AMF), wherein the first wireless device is a user equipment (UE) or a component in a radio access network (RAN), and wherein the third network entity is a UAS service supplier (USS).

8. The apparatus of claim 1, further comprising at least one of a transceiver or an antenna coupled to the at least one processor, wherein to receive the first information, the at least one processor is configured to receive the first information via at least one of the transceiver or the antenna, wherein the at least one wireless device is at least one of an unmanned aerial vehicle, a drone, or a user equipment (UE).

9. The apparatus of claim 1, wherein the at least one processor is further configured to: receive, from one of the second network entity or a fourth network entity, a request for fourth information regarding the flightpath of the at least one wireless device; and transmit, to at least one of the second network entity and the fourth network entity, the fourth information regarding the flightpath of the at least one wireless device based on the second information.

10. The apparatus of claim 1, wherein the at least one processor is further configured to:
receive, from the second network entity, a request to receive updates regarding the flightpath of the at least one wireless device;
receive, from one of the third network entity, the first wireless device, or a fourth network entity, fourth information comprising an update to the second information regarding the flightpath of the at least one wireless device; and
transmit, to the second network entity, fifth information regarding the update to the second information regarding the flightpath of the at least one wireless device based on the fourth information.

11. An apparatus for wireless communication at a second network entity, comprising: a memory; and
at least one processor coupled to the memory and, based at least in part on information stored in the memory, the at least one processor is configured to:
receive, from a first wireless device, first information regarding a flightpath of at least one wireless device, wherein the first information corresponds to a first information format; and
transmit, to a first network entity, an indication to store second information regarding the flightpath of the at least one wireless device, wherein the second information corresponds to a second information format.

12. The apparatus of claim 11, wherein the at least one processor is further configured to:
transmit, to the first network entity, a request for third information regarding the flightpath of the at least one wireless device; and
receive, from the first network entity, the third information regarding the flightpath of the at least one wireless device based on the second information.

13. The apparatus of claim 11, wherein the at least one processor is further configured to:
transmit, to the first network entity, a request to receive updates regarding the flightpath of the at least one wireless device; and
receive, from the first network entity, third information regarding an update to the flightpath of the at least one wireless device.

14. The apparatus of claim 11, wherein the first information format and the second information format are associated with an identification of a sequence of waypoints via one or more of a first ellipsoid point, a second ellipsoid point with an uncertainty circle, a third ellipsoid point with an uncertainty ellipse, a polygon, a fourth ellipsoid point with a first altitude, a fifth ellipsoid point with a second altitude and an uncertainty ellipsoid, or an ellipsoid arc.

15. The apparatus of claim 14, wherein the first information format and the second information format are different information formats.

16. The apparatus of claim 14, wherein a set of waypoints in the sequence of waypoints are associated with a set of timestamps, wherein the set of timestamps comprises one or more of an absolute time or a relative time.

17. The apparatus of claim 11, wherein the first information regarding the flightpath of the at least one wireless device comprises at least one identifier (ID) of the at least one wireless device, wherein the at least one ID is one of a general public subscription identifier (GPSI), a subscription permanent identifier (SUP I), or a civilian aviation authority (CAA) level ID.

18. The apparatus of claim 11, wherein the first network entity is an unmanned aerial vehicle administration server or an unmanned aircraft system network function (UAS-NF), wherein the second network entity is an access and mobility management function (AMF), and wherein the first wireless device is a user equipment (UE) or a component in a radio access network (RAN).

19. The apparatus of claim 11, further comprising at least one of a transceiver or an antenna coupled to the at least one processor, wherein to receive the first information, the at least one processor is configured to receive the first information via at least one of the transceiver or the antenna, wherein the at least one wireless device is at least one of an unmanned aerial vehicle, a drone, or a user equipment (UE).

20-30. (canceled)
